(19) United States
(12) Patent Application Publication
(10) Pub. No.: US 2025/0062561 A1
(43) Pub. Date: Feb. 20, 2025

(54) CHIP CONNECTOR WITH IMPROVED TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TZU-YAO HWANG, New Taipei (TW)

(21) Appl. No.: 18/806,513

(22) Filed: Aug. 15, 2024

(30) Foreign Application Priority Data
Aug. 16, 2023 (CN) 202311032510.2
Aug. 16, 2023 (CN) 202322208379.2

(51) Int. Cl. H01R 13/24

(52) U.S. Cl. CPC H01R 13/245

(57) ABSTRACT

A chip connector includes: an insulating housing defining an upper face, a lower face, and plural terminal grooves extending through the upper face and the lower face; and plural conductive terminals received in the terminal grooves respectively, each of the terminals including a main portion retained in the insulating housing and an elastic arm extending obliquely and upwards from an upper end of the main portion, the elastic arm having a contacting portion extending out of the upper face, wherein each of the terminals further includes an attachment portion integrally formed with the main portion, the attachment portion is located below the elastic arm and separately faces the main portion, the elastic arm defines a notch, and an upper end of the attachment portion is located under the notch for a jig to clamp the upper end of the attachment portion through the notch.

### BACKGROUND OF THE INVENTION

### Field of the Invention

The present invention relates to a chip electrical connector with improved terminals.

### Description of Related Arts

A transmission rate of current electrical connectors is getting higher and higher, and the transmission bandwidth of some connectors has even reached 128 Gbps. The electrical connector with such high transmission speed has a higher requirement for lower terminal impedance.

In order to reduce the impedance of the terminals, multiple bends of the terminals are often needed which would significantly increase terminal stamping costs and plating costs.

Therefore, it is desired to provide a chip electrical connector with improved terminals.

### SUMMARY OF THE INVENTION

The object of the present invention is to provide a chip connector with improved terminals.

To achieve the above object, a chip connector comprises: an insulating housing defining an upper face, a lower face, and a plurality of terminal grooves extending through the upper face and the lower face; and a plurality of conductive terminals received in the terminal grooves respectively, each of the terminals comprising a main portion retained in the insulating housing and an elastic arm extending obliquely and upwards from an upper end of the main portion, the elastic arm having a contacting portion extending out of the upper face, wherein each of the terminals further comprises an attachment portion integrally formed with the main portion, the attachment portion is located below the elastic arm and separately faces the main portion, the elastic arm defines a notch, and an upper end of the attachment portion is located under the notch for a jig to clamp the upper end of the attachment portion through the notch.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a chip connector of a first embodiment of this present invention, wherein only one terminal and part of an insulating housing are shown in figures;

FIG. 2 is another perspective view of the chip connector of FIG. 1;

FIG. 3 is an exploded perspective view of the chip connector of FIG. 1;

FIG. 4 is a cross-sectional view of the chip connector along line A-A in FIG. 1;

FIG. 5 is an exploded perspective view of the chip connector of FIG. 2;

FIG. 6 is a perspective view of the terminal of FIG. 5;

FIG. 7 is a side elevational view of the terminal of FIG. 6;

FIG. 8 is a front elevational view of the terminal of FIG. 6;

FIG. 9 is a perspective view of a chip connector of a second embodiment of this present invention;

FIG. 10 is an exploded perspective view of the chip connector of FIG. 9;

FIG. 11 is another exploded perspective view of the chip connector of FIG. 9;

FIG. 12 is a perspective view of the terminal of FIG. 11;

FIG. 13 is a side elevational view of the terminal of FIG. 12;

FIG. 14 is a cross-sectional view of the chip connector along line B-B in FIG. 9; and

FIG. 15 is a front elevational view of the terminal of FIG. 12.

### DETAILED DESCRIPTION OF THE PREFERRED EMBODIMENT

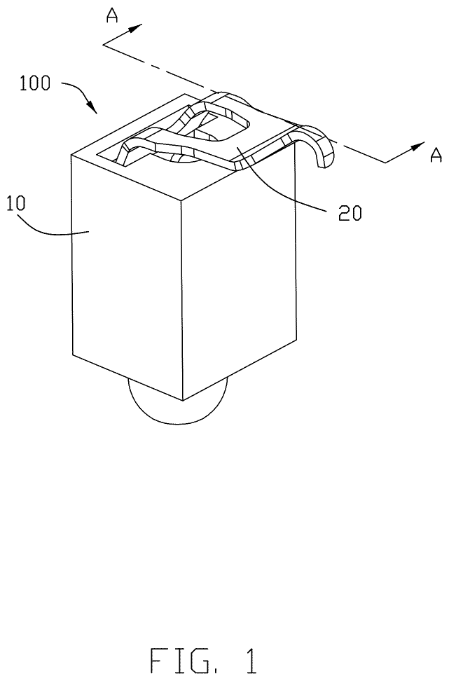

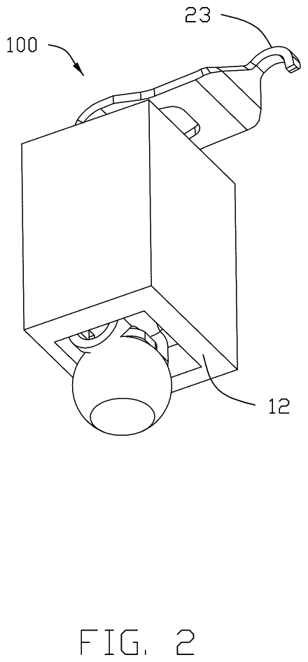

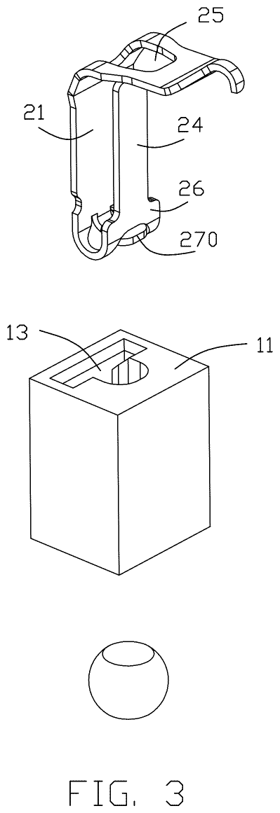

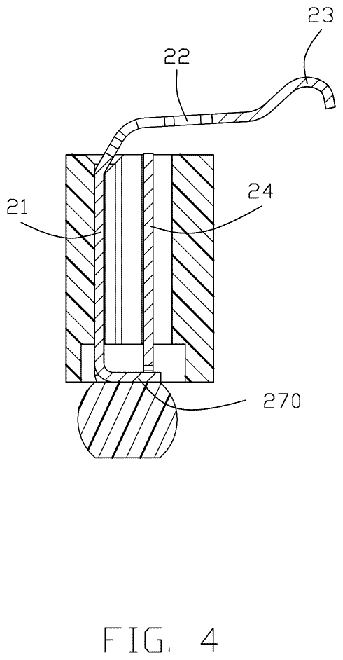

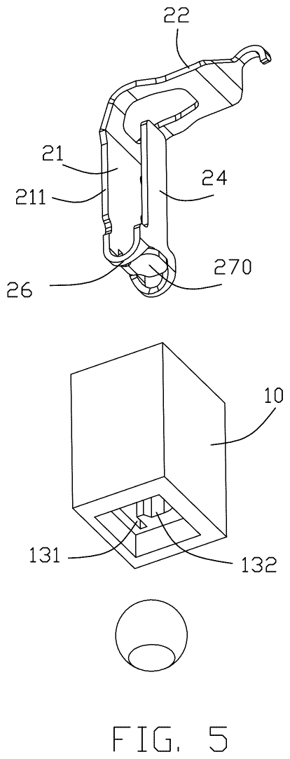

Referring to FIGS. 1-4, an electrical connector in a first embodiment is illustrated, the electrical connector is of a chip connector 100 for connecting a chip module to a printed circuit board. The chip connector 100 comprises an insulating housing 10 and a plurality of terminals 20 retained in the insulating housing 10. The insulating housing 10 has an upper face 11, a lower face 12 and plural terminal grooves 13 going through the upper face 11 and the lower face 12, and the terminals 20 are received and retained in the terminal grooves 13 respectively. In figures, only part of the insulating housing 10 with one terminal groove 13 and one terminal 20 is shown. In fact, the chip connector 100 has hundreds or thousands of terminal grooves 13 and terminals 20. Each terminal 20 has a main portion or fixing portion 21 for fixing the terminal in the housing 10, an elastic arm 22 and an attachment portion 24 integrally formed with the main portion 21. The elastic arm 22 has a contacting portion 23 located above the upper face 11. The attachment portion 24 is located under the elastic arm 22 and separately faces the main portion 21 for reducing an impedance of the terminal 20. The elastic arm 22 has a notch 25 which goes through the elastic arm 22 along an upper-down direction/a thickness direction of the metal sheet. An upper end of the attachment portion 24 is located just below the notch 25. When seen from a top view of the terminal 20, the upper end of the attachment portion 24 is in the notch 25, and thus, a jig can go through the notch 25 to pick up the terminal 20 for installing. One jig can pick up only one terminal at one time, or 2-3 terminals or more at one time. Referring to FIGS. 4-5, the terminal groove 13 comprises a fixing groove 131 and a receiving groove 132 communicating with the fixing groove 131. The main portion 21 is received and retained in the fixing groove 131, and the elastic arm 22 extends out from the fixing groove 131. The attachment portion 24 is received in the receiving groove 132, two side edges of the attachment portion 24 are not interfered with an inner wall of the receiving groove 132. A side edge of the main portion 21 is a cutting face 211 for connecting with a strip which has been cut off before the terminal 20 is assembled into the terminal groove 13.

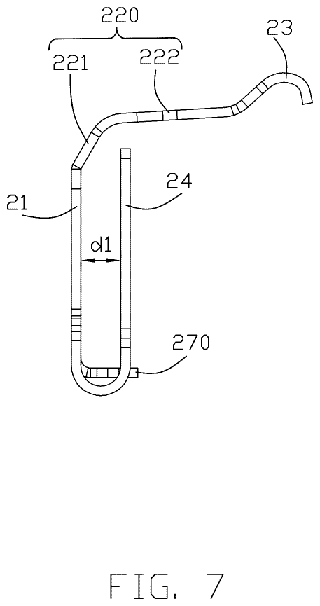

Referring to FIG. 7, the terminals 20 are stamped from a metal plate, the main portion 21 and the attachment portion 24 extend vertically and are parallel to each other. A distance between the attachment portion 24 and the main portion 21 is d1 which is not less than three times of a thickness of the metal plate. Preferably, d1 is not less than 0.15 mm and is between 4 and 5 times of the thickness of the mental plate. Preferably, the d1 is between 0.2 mm and 0.25 mm. In this embodiment, the thickness of the mental plate is 0.05 mm and the d1 is 0.22 mm.

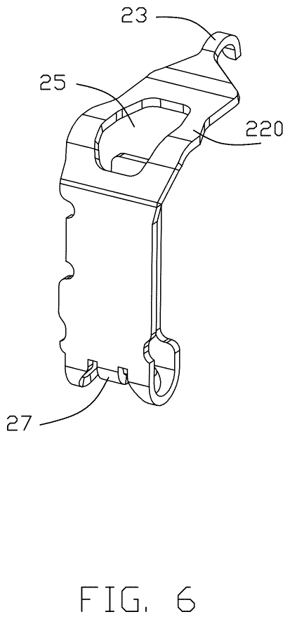

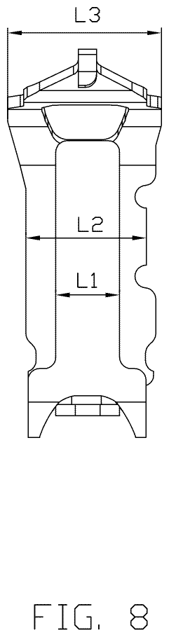

Referring to FIGS. 5-8, the attachment portion 24 folds upward from the lower end of the main portion 21, and a height of the attachment portion 24 is not less than one-third of a height of the main portion 21. In this embodiment, the attachment portion 24 extends upward and exceeds a junction of the main portion 21 and the elastic arm 22, so there is an overlap between the attachment portion 24 and the elastic arm 22 in the up-down direction as shown clearly in FIG. 7. The attachment portion 24 and the main portion 21 are united by a first connecting portion 26, and the first connecting portion 26 is of an upward arc shape. A tail portion 27 is formed by tearing from the first connecting portion 26 and with a horizontal pad 270. A width L1 of the attachment portion 24 is less than a width L2 of the main portion 21. Both the attachment portion 24 and the main portion 21 have a left side edge and a right side edge. The attachment portion 24 is located in front of the main portion 21. In this embodiment, the elastic arm 22 comprises an elastic portion 220 and the contacting portion 23 located at a free end of the elastic portion 220. The notch 25 is located at the elastic portion 220. In order to make the notch 25 at the elastic portion 220 conveniently, a widest width L3 of the elastic portion 220 is set greater than a width L2 of the main portion 21. The elastic portion 220 comprises an inclined portion 221 extending obliquely and upward from the main portion 21 and a substantially horizontal portion 222 extending horizontally from the inclined portion 221. The notch 25 spans the inclined portion 221 and the horizontal portion 222. As the thickness of the metal plate is 0.05 mm and the widest width L3 of the elastic portion 220 is larger than the width L2 of the main portion 21, it is hard to make the elastic portion 220 elastically deformed without the notch 25. So the notch 25 can not only allow the jig to pass through, but also improve the elasticity of the elastic arm 22.

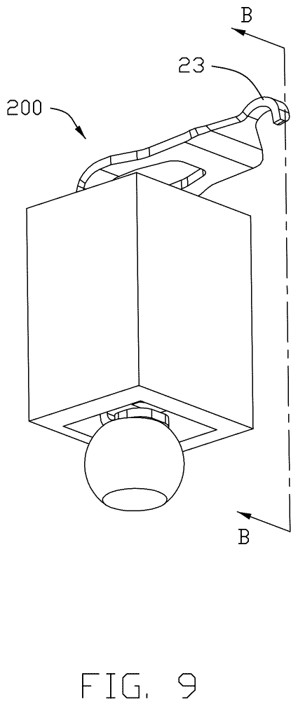

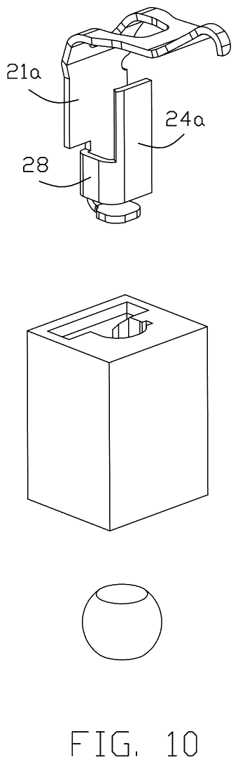

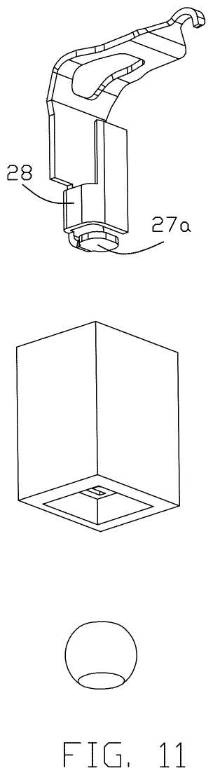

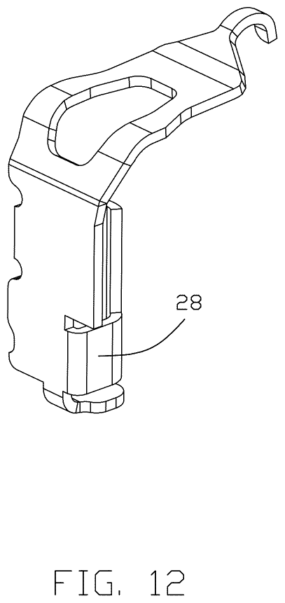

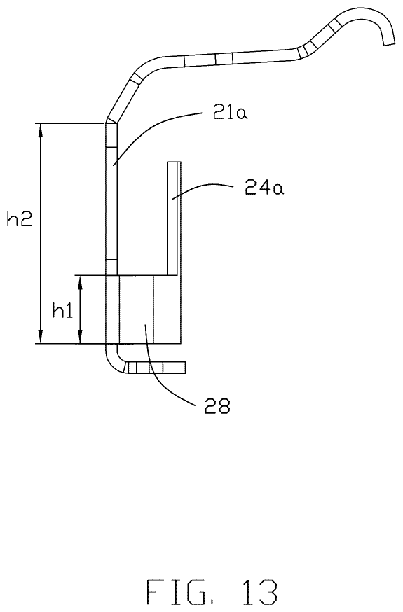

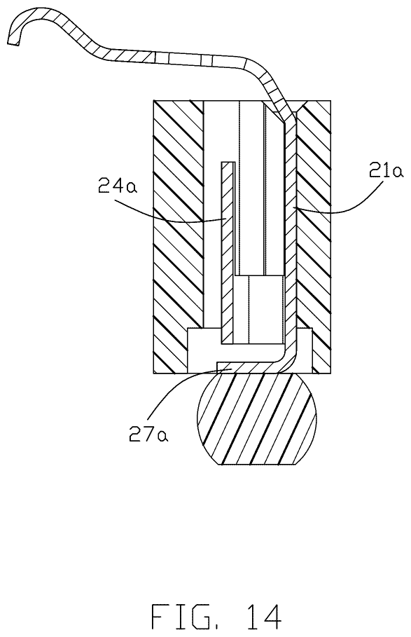

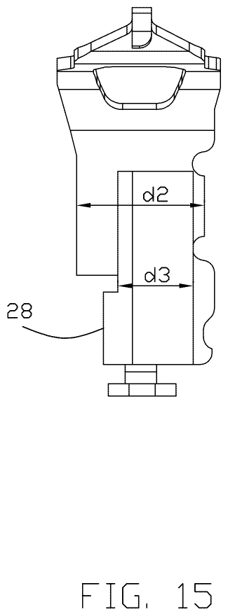

Referring to FIGS. 9-15, a chip connector 200 in a second embodiment is illustrated. The chip connector 200 is roughly the same as the chip connector 100 in the first embodiment. In this embodiment, the same structures are labeled with same symbols and are not described in detail again, only the main differences are described hereinafter. In this embodiment, the attachment portion 24a and the main portion 21a are connected with a second connecting portion/a side connecting portion 28, the second connecting portion 28 directly connects the left side edge of the main portion 21a and the left side edge of the attachment portion 24a. A height of the second connecting portion 28 is less than a half of the height h2 of the main portion 21a. The second connecting portion 28 is close to a lower end of the main portion 21a, the width of the main portion 21a close to the elastic portion 220 is d2, the width of the main portion closer to the second connecting portion 28 is d3, d2 is larger than d3. The second connecting portion 28 is under the main portion 21a with the width d2, that is, the main portion 21a with the width d2 extends left and exceeds the second connecting portion 28 located below the main portion 21a. The tail portion 27a is formed by bending from a lower end of the main portion 21a. And the side connecting portion 28 is perpendicular to the attachment portion and the main portion.

The above-mentioned embodiments are only preferred embodiments of the present invention, and should not limit the scope of the present invention, any simple equivalent changes and modifications made according to the claims of the present invention and the contents of the description should still belong to the present invention.

1. A chip connector comprising:
an insulating housing defining an upper face, a lower face, and a plurality of terminal grooves extending through the upper face and the lower face; and
a plurality of conductive terminals received in the terminal grooves respectively, each of the terminals comprising a main portion retained in the insulating housing and an elastic arm extending obliquely and upwards from an upper end of the main portion, the elastic arm having a contacting portion extending out of the upper face;
wherein each of the terminals further comprises an attachment portion integrally formed with the main portion, the attachment portion is located below the elastic arm and separately faces the main portion, the elastic arm defines a notch, and an upper end of the attachment portion is located under the notch for a jig to clamp the upper end of the attachment portion through the notch.

2. The chip connector as claimed in claim 1, wherein the terminal is integrally stamped from a metal sheet, the main portion and the attachment portion extend vertically and are parallel to each other, and a distance between the main portion and the attachment portion is more than three times of a thickness of the metal sheet.

3. The chip connector as claimed in claim 2, wherein the distance between the main portion and the attachment portion is 4 to 5 times of the thickness of the metal sheet.

4. The chip connector as claimed in claim 3, wherein the thickness of the metal sheet varies from 0.04 mm to 0.06 mm, and the distance between the main portion and the attachment portion varies from 0.20 mm to 0.25 mm.

5. The chip connector as claimed in claim 1, wherein a height of the attachment portion is more than one third of a height of the main portion.

6. The chip connector as claimed in claim 1, wherein the attachment portion folds upward from the lower end of the main portion.

7. The chip connector as claimed in claim 6, wherein the attachment portion and the main portion are connected by a first connecting portion, and a tail portion is formed by tearing from the first connecting portion.

8. The chip connector as claimed in claim 7, wherein a horizontal pad is formed at a free end of the tail portion.

9. The chip connector as claimed in claim 1, wherein the attachment portion and the main portion are connected by a second connecting portion, the second connecting portion is connected with same side edges of the attachment portion and the main portion.

10. The chip connector as claimed in claim 9, wherein a height of the second connecting portion is less than a half of a height of the main portion.

11. A chip connector comprising:
an insulating housing defining an upper face, a lower face, and a plurality of terminal grooves going through the upper face and the lower face; and
a plurality of conductive terminals received in the terminal grooves respectively, each of the terminals comprising a fixing portion and an elastic arm extending slantwise and upwards from the fixing portion, the elastic arm having a contacting portion located above the upper face of the insulating housing;
wherein the terminal is integrally stamped from a metal sheet and the terminal further comprises an attachment portion located below the elastic arm, the attachment portion faces and is parallel to the main portion with a certain distance, and a height of the attachment portion is more than one third of a height of the main portion and the certain distance between the main portion and the attachment portion is 4 to 5 times of the thickness of the metal sheet.

12. The chip connector as claimed in claim 11, wherein the thickness of the metal sheet is 0.04 to 0.06 mm, and the distance between the main portion and the attachment portion is 0.20 mm to 0.25 mm.

13. The chip connector as claimed in claim 11, wherein the elastic arm has a notch penetrating the elastic arm along an upper-down direction, and the attachment portion is located under the notch.

14. The chip connector as claimed in claim 13, wherein the notch is adapted for a jig to pass through and pick up the terminal.

15. The chip connector as claimed in claim 11, wherein the attachment portion and the main portion are connected with a side connecting portion perpendicular to the attachment portion and the main portion.

16. The chip connector as claimed in claim 13, wherein the attachment portion and the main portion are connected with two lower connecting portions, and a soldering portion is located between the two lower connecting portions.
